(19) United States
(12) Patent Application Publication
(10) Pub. No.: US 2021/0097786 A1
(43) Pub. Date: Apr. 1, 2021

(54) METHOD AND PRODUCT FOR MONITORING AND RESPONDING TO COMPONENT CHANGES IN AN AUTONOMOUS DRIVING SYSTEM

(71) Applicant: Continental Automotive Systems, Inc., Auburn Hills, MI (US)

(72) Inventors: Joseph A. LaBarbera, Auburn Hills, MI (US); Scott A. Millsap, Grand Blanc, MI (US); Clinton L. Schumann, Holly, MI (US); Scott T. Sanford, Swartz Creek, MI (US); Geoff Bauer, Oxford, MI (US); Varunraj Arunrao Shedge, Auburn Hills, MI (US); Jason Schwegler, Grand Blanc, MI (US); Michael S. Wyciechowski, Grand Blanc, MI (US)

(73) Assignee: Steering Solutions IP Holding Corporation, Auburn Hills, MI (US)

(21) Appl. No.: 17/014,078

(22) Filed: Sep. 8, 2020

Related U.S. Application Data
(60) Provisional application No. 62/902,707, filed on Sep. 19, 2019.

(51) Int. Cl. G07C 5/08; G07C 5/00; G05D 1/00; G05D 1/02; B60W 60/00; B60W 10/04; B60W 10/18; B60W 10/20

(52) U.S. Cl. CPC G07C 5/0808; B60W 2530/18; G05D 1/0088; G05D 1/0212; B60W 60/001; B60W 10/04; B60W 10/18; B60W 10/20; G05D 1/0287; B60W 2510/18; B60W 2510/20; B60W 2710/18; B60W 2710/20; B60W 2554/40; G07C 5/008

(57) ABSTRACT

A number of illustrative variations may include a method or product for monitoring and responding to component, system, or module changes in an autonomous driving system.

### CROSS-REFERENCE TO RELATED APPLICATIONS

This application claims the benefit of U.S. Provisional Application Serial No. 62/902,707 filed Sep. 19, 2019.

### TECHNICAL FIELD

The field to which the disclosure generally relates to includes autonomous driving systems.

### BACKGROUND

Vehicles typically include a number of systems or modules for driving including but not limited to systems or modules for acceleration of the vehicle, deceleration of the vehicle, and steering of the vehicle.

### SUMMARY OF ILLUSTRATIVE VARIATIONS

A number of illustrative variations may include a method or product for monitoring and responding to component, system, or module changes in an autonomous driving system.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1A depicts an illustrative variation in which a partial view of a flow chart depicts generally how component degradation may be detected and a curvature capability output for response or adaptation thereto by an autonomous driving system, wherein FIGS. 1A and 1B are to be view together as a complete flow chart.

FIG. 1B depicts an illustrative variation in which a partial view of a flow chart depicts generally how component degradation may be detected and a curvature capability output for response or adaptation thereto by an autonomous driving system, wherein FIGS. 1A and 1B are to be view together as a complete flow chart.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement such as but not limited to roadwheels, treads, casters, rollers, propellers, gas thrusters, liquid thrusters, or ion driven thrusters, or any other known means of driven automotive vehicle movement.

As used herein, “wheels” or “wheel,” even when modified by a descriptive adjective such as but not limited to in the recitation of “steerable roadwheels,” “steerable wheels,” “road wheels,” or “driven wheels,” may refer to a traditional road wheel and tire arrangement, but may also refer to any modification to the traditional road wheel and tire arrangement such as but not limited to rimless mag-lev tires, ball tires, or any other known means of automotive movement such as but not limited to treads, casters, rollers, propellers, or gas thrusters, liquid thrusters, or ion driven thrusters.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

As used herein, “path” generally refers to a determined route of travel for a vehicle. Additionally, as used herein, “trajectory” generally refers to a dynamic path for a vehicle that may be changed by the planner module based upon at least one aspect of the vehicle's travel environment such as but not limited to road surface conditions. Additionally, a vehicle's trajectory may also be based upon at least one determined vehicle component, system, or module capability. Changes to a vehicle's trajectory may include a vehicle's manner of travel to vehicle travel characteristics such as but not limited to the distance by which the vehicle trails any other vehicle while travelling, the speed of the vehicle, the braking strategies or driving style of the vehicle, the acceleration rate of the vehicle for any given situation, or the merging rate of the vehicle , based upon at least one aspect vehicle's travel environment or at least one determined vehicle component, system, or module capability.

As used herein, “capability module” may generally refer to any module that outputs a vehicle capability determination, such as but not limited to a vehicle acceleration capability determination, a vehicle deceleration capability determination, a vehicle steering capability determination or a vehicle curvature capability determination.

In a number of illustrative variations, a vehicle may have a steering system that allows a driver to change the vehicle's direction or divert it from a path that it may be traveling in. The vehicle's steering system may also be autonomous in that the vehicle may steer itself toward a predetermined location that has been communicated to it without assistance or interference from a driver. The vehicle may also include an obstacle avoidance system that allows the vehicle to sense objects in its path and avoid them.

In a number of illustrative variations, a vehicle may be equipped with a steering interface that may comprise a joystick, a trackball, a slider, a throttle, a pushbutton, a toggle switch, a lever, a touchscreen, a mouse, or any other known means of user input.

In a number of illustrative variations, an autonomous driving system may be programmed with or be in communication with any number of logic modules arranged to autonomously address a number of areas of control within the realm of vehicle steering and travel including but not limited to vehicle acceleration, vehicle braking, autonomous path planning, performance capability monitoring and management, and an autonomous steering system for at least lateral control of the vehicle. The logic for the modules of the autonomous steering system may account for driver assistance or intervention in the steering or driving of the vehicle.

In a number of illustrative variations, an autonomous driving vehicle may be equipped with any number of sensors and monitoring systems for determining the state of health or degradation of any number of vehicle systems such as but not limited to drive systems, braking systems, electrical systems, exhaust systems, fuel systems, suspension systems, and any other vehicle systems, or individual vehicle components such as but not limited to actuators, gears, pumps, injectors, plugs, cylinders, wheels, tires, or steering interfaces by which a driver may steer the vehicle.

In a number of illustrative variations, any vehicle component, system, or module may have an initial integrity. As used herein, “initial integrity” may refer to the state of health or degradation of any vehicle component, system, or module as measured from a baseline state of health or degradation such as but not limited to the state of health or degradation of a vehicle component, system, or module as recorded by a technician at the time of servicing, repairing, or inspecting the vehicle. Additionally, “initial integrity” may refer to the to the state of health or degradation of any vehicle component, system, or module as measured from the time of its manufacture or installation, or may refer to the to the state of health or degradation of any vehicle component, system, or module as measured from the time that the vehicle is started up for the very first time. Generally, the “initial integrity” of a vehicle component, system, or module may refer to that component, system, or module's fitness for use according to at least one of its intended purposes as measured from a particular or “initial” point in time. The foregoing are not intended to be limiting examples or definitions of “initial integrity”—other milestones in a vehicle component, system, or module's life may also be used to establish a baseline state of degradation or health defining “initial integrity.”

In a number of illustrative variations, a determined state of health or degradation of any vehicle component, system, or module may be correlated to the vehicle's performance as a whole or the performance of particular vehicle components, systems, or modules, and translated into at least one performance capability determination. The at least one performance capability rating may be used by a planner module to determine an appropriate path and trajectory for the vehicle based on the at least one performance capability determination.

In a number of illustrative variations, the systems or components of a vehicle or any combinations thereof may operate according to logic modules by way of software or machine logic. In such cases, any number of modules may be combined together or broken into smaller modules.

In a number of illustrative variations, an autonomous vehicle may be equipped with a planner module. The planner module may refer to a module of software housed in electronically accessible memory housed onboard the vehicle, or accessible via cloud services, or accessible in any other known way in which software may be accessed, or may refer to the planner module software or planner algorithm or the hardware being used to execute the planner module software or algorithm. The planner module software or algorithm may be configured to be executed on a dedicated piece of processing hardware either onboard or remote from the vehicle and communicated to the vehicle.

In a number of illustrative variations, the planner module may plan an autonomous driving vehicle path and trajectory. The planner module may receive or compute a planned destination via computed or received destination coordinates, a computed or received absolute or relative location with regard to the vehicle, or a location within a network of potential destinations, and plan a path for vehicle travel based on known extent roads or vehicle pathways, previous paths taken by the vehicle, paths charted by other vehicles on a network, or by any known means of planning a vehicle path or any combination thereof. In some such illustrations, a vehicle path and trajectory may be computed or received by the autonomous planner module and modified by the planner module based at least upon other data received or collected by the vehicle or other vehicles in a network such as but not limited to local terrain data, road closures data, or traffic data. As a non-limiting example, a vehicle may be travelling autonomously on a received, retrieved, or computed autonomous vehicle path, when the planner module of the vehicle receives data from a network of connected vehicles that indicates that vehicles have been hydroplaning on the road ahead whereas a certain alternative path might pose no such hazard to the vehicle. In Such a case, the vehicle's autonomous planner module may modify the vehicle path with a detour that avoids the road on which frequent hydroplaning has occurred. Similarly, in such illustrative variations, road conditions such as but not limited to road surface friction coefficients, surface quality, visibility conditions such as but not limited to low visibility conditions caused by debris, dust, smoke, reflections, or weather conditions, may be collected, computed, or received by the planner module of the vehicle and may be used in determining if or how to modify the planned vehicle path or trajectory. Additionally, sensors or modules monitoring the vehicle's systems or individual components may communicate a condition or state of health of a vehicle system, component, or module to the planner module. The autonomous planner module may then modify the vehicle path or trajectory based on the condition or state of health of any number of vehicle systems, components, or modules. In some cases, the planner module may compute, retrieve, or receive at least one vehicle capability determination which may be determined based at least upon the condition or state of health of a particular vehicle system or vehicle component from a vehicle capability module which may receive such a state of health or degradation from the sensors or modules monitoring the vehicle's systems or individual components. As a non-limiting example, an autonomous vehicle may be equipped with at least one Engine Control Unit (ECU) that communicates with an Electronic Power Steering (EPS) system. In such a case, any number components that communicate with any number of the ECUs such as but not limited to sensors, transistors, switches, relays, amplifiers, or actuators may fail or shutdown due to a fault such as but not limited to an underpowering fault in a position sensor, a gate drive fault in a field-effect transistor (FET), a fault due to overheating in an insulated-gate bipolar transistor (IGBT), a fault due to a mechanical or electrical issue with a switch or relay, a fault in an amplified due to underpowering, or a fault in an actuator due to wear and tear, or any other electrical, mechanical, or thermal issue with any similar or associated components. In such cases, an associated ECU may go into a fault mode or fail because one of the components with which it communicates has failed, and this may be communicated to the planner module in the form of a vehicle capability determination via a vehicle capability module so that the planner module may appropriately adjust the planned path or trajectory, re-compute the planned path or trajectory, or seek and receive an adjustment to the planned path or trajectory from some other source based at least upon the failure. As another non-limiting example, the EPS system itself may fail due to electrical or thermal issues with the EPS circuit components, or from high friction in a mechanical component such as but not limited to a column assist motor. In some such cases, failures affecting the steering of the vehicle may be communicated to the planner module, by any system in which the failure occurs, in the form of a vehicle capability determination via at least one vehicle capability module. In some such cases the planner module or a submodule thereof, or a vehicle capability module, may constantly or periodically poll steering systems to discover such failures or similar or associated failures. When relevant failures resulting in modified vehicle capabilities are presented to the planner module, the planner module may appropriately adjust the planned path or trajectory, re-compute the planned path or trajectory, seek, or receive an adjustment to the planned path or trajectory from some other source based at least upon the failure.

In a number of illustrative variations, the autonomous vehicle may comprise a Motion Control System (MCS) that may collect or receive data from any vehicle system concerned with the motion of the vehicle such as but not limited to a braking system, a steering system, an engine control system, a fuel system, or electrical power generation and delivery system. In some such cases, the MCS may be in direct or indirect communication with a planner module.

In a number of illustrative variations, the performance capabilities of an autonomous vehicle may be determined on demand, periodically, or continuously. The performance capability may be based upon the vehicle speed or the state of health or degradation of vehicle components, systems, or modules as well as other things like road surface conditions and tire or wheel conditions. As a non-limiting examples, factors like high speed will cause a curvature capability determination to be lower whereas a low speed may allow a curvature capability estimate that follows a simple kinetic bicycle model. As another non-limiting example, a low road surface friction coefficient may cause certain performance capability determinations such as but not limited to steering capability or braking capability determinations to be lower on icy surfaces and higher when the road surface friction coefficient is higher such as on dry concrete.

In a number of illustrative variations, the planner module may, in light of the state of health or degradation of vehicle systems, components, or modules, or in light of at least one vehicle capability determination, compute, seek, or receive a new autonomous vehicle path or trajectory, or a new path and trajectory.

In a number of illustrative variations, a vehicle may be equipped with a motion control system that is in communication with a planner module. The motion control system may collect or receive data on the state of health or degradation of at least one vehicle system or vehicle component. The motion control system may track such data for translation into logic for the operation of the autonomous vehicle. This data or operational logic may be communicated to the planner module or may be accessible to the planner module.

In a number of illustrative variations, an autonomous vehicle path and trajectory may be computed while assuming certain future operating conditions due to limitations imposed by the state of health or degradation of certain vehicle systems or components. As a non-limiting example, if a component of the steering system is degraded to the point that the minimum turning radius has widened such that tight right turns have become infeasible, the planner module may compute a new autonomous path and trajectory that eliminates the necessity to make any such tight right turns. In computing a new autonomous path, present operating condition considerations or a predicted future operating condition considerations such as but not limited to vehicle speed, road conditions, vehicle braking capability, engine capability, fuel levels, oil levels, vehicle component conditions, or operating logic conditions may be taken into account. As a non-limiting example, during a long road trip, the planner module may predict based upon current operating conditions that, in about 900 miles from the current vehicle location, the vehicle braking system will be degraded to the point that it would be inadvisable for the vehicle to travel above 60 miles per hour on the highway. The planner module may thus compute or seek an autonomous travel path and trajectory based upon this prediction. Additionally, any number of vehicle systems or modules may produce a warning regarding such conditions that may be communicated to a human occupant of the vehicle, to a central processing module or hub, to the Cloud, or anywhere else that data may be transmitted.

In a number of illustrative variations, a planner module may determine not only the route by which the vehicle travels based upon at least one determined vehicle capability but also may determine the manner in which the vehicle travels the determined route. As a non-limiting example, if the planner module receives or retrieves at least one determined vehicle capability indicating that the vehicle's ability to brake as been degraded, the planner module may determine that the manner in which the vehicle should follow the determined route is one in which planned braking distances must be extended and accounted for in the determined route. As another non-limiting example if the planner module receives or retrieves at least one determined vehicle capability indicating that the vehicle's drive system or ability to accelerate as been degraded, the planner module may determine that the manner in which the vehicle should follow the determined route is one in which planned acceleration times must be extended and accounted for in the determined route.

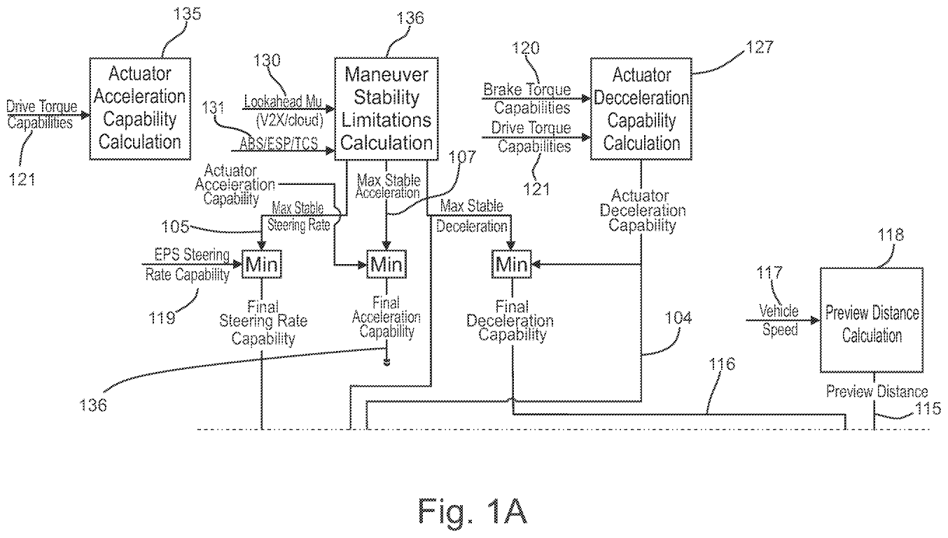

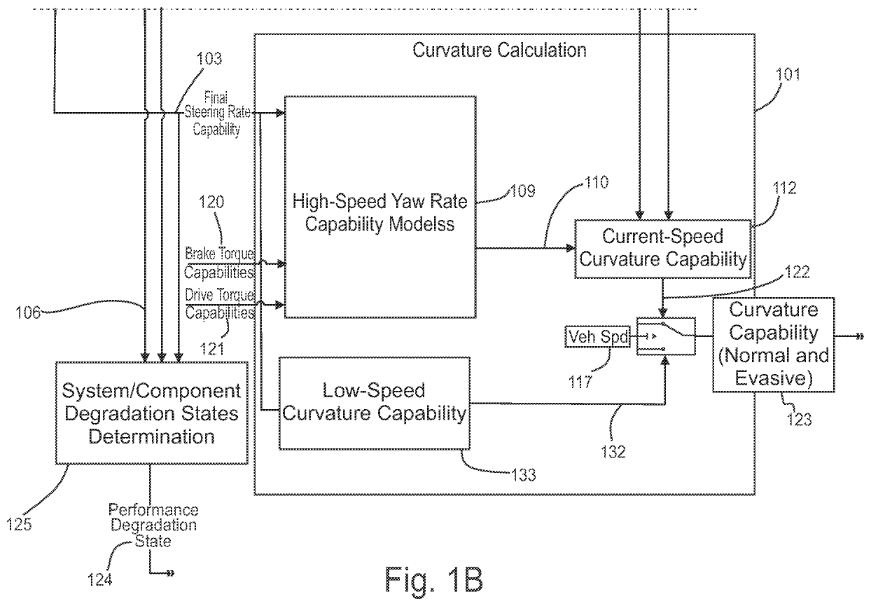

Referring now to FIG. 1, a vehicle comprising an autonomous steering system may be travelling to a destination according to a predetermined autonomous vehicle path. In such a case, the vehicle may be equipped with a number of software modules which communicate with or monitor vehicle systems, components, or sensors. in order to ensure that travel along the predetermined autonomous vehicle path remains viable or reasonable. A number of these modules may be used to determine the vehicle's ability to maneuver in a lateral direction at a given vehicle speed. The software modules may produce any number of outputs for use by other vehicle systems, components, or sensors including but not limited to a Final Curvature Capability 123 that may function as an estimate of the vehicle's capability to achieve any given curvature by steering at a given speed, a Performance Degradation State 124 that may function as an indicator to vehicle systems, components, modules, or sensors to adjust their readings, communications or calculations based on at least vehicle capability determination based on the state of health or degradation of at least one vehicle system, component, or module and a Final Acceleration Capability 116 that may function as an estimate of the vehicle's current ability to generate a driving power for acceleration. For the purpose of calculating the Final Curvature Capability 123, the vehicle may comprise a Curvature Calculation Module 101 for determining the vehicle's ability to turn according to any pre-planned curvature in a predetermined autonomous vehicle path. In order to determine the vehicle's ability to turn according to a pre-planned curvature in a predetermined vehicle path, data regarding the path and the vehicle itself must be collected and processed. To that end, a High-speed Yaw Rate Capability Models module 109, may receive a Final Steering Rate Capability 103 that may be determined by correlating a Max Stable Steering Rate 105 to an Electronic Power Steering Rate Capability 119. The Max Stable Steering Rate 105 may be determined by a Maneuver Stability Limitations Calculation module 136 that may correlate a Lookahead Mu 130 or Lookahead Friction Coefficient to the vehicle's Anti-lock Braking System/Electronic Stability Control/Traction Control System data 131 for the driving surface ahead. Lookahead Mu 130 may be obtained via vehicle sensors, from Vehicle-to-vehicle communication or V2X communication, or from the Cloud. Based at least on the Final Steering Rate Capability 103, and based upon Brake Torque Capabilities 120 and Drive Torque Capabilities 121 of the vehicle, the High-speed Yaw Rate Capability Models 109 module 102 may produce and supply a High-speed Yaw Rate Capability Model calculation 110, via the use of at least one high-speed yaw rate capability model, to the Current-Speed Curvature Capability module 112. The Current-Speed Curvature Capability module 112 may utilize the High-speed Yaw Rate Capability Model calculation 110 along with a Preview Distance calculation 115, which may be an estimate of vehicle travel distance while traveling along a predetermined path, as calculated by a Preview Distance Calculation module 118, which may be based at least upon a Vehicle Speed signal 117, as well as a Final Deceleration Capability calculation 116, which may be based at least upon Actuator Deceleration Capability 104 and a Max Stable Deceleration 106 to provide a Current-Speed Curvature Capability calculation 122. Actuator Deceleration Capability 104 may be an estimate representing the vehicle's ability to autonomously decelerate by way of braking or manipulation of the vehicle's drivetrain or brakes and may be supplied by an Actuator Deceleration Capability Calculation module 127. The Actuator Deceleration Capability Calculation module 127 may estimate the Actuator Deceleration Capability 104 based at least upon Drive Torque Capabilities 121 and Brake Torque Capabilities 120. Drive Torque Capabilities 121 may refer to at least one estimate of the abilities of drivetrain components or systems to affect the drive torque output of the vehicle such as but not limited to a vehicle transmission's ability to change a vehicle gear ratio thus affecting drive torque, and Brake Torque Capabilities 120 may refer at least one estimate of a vehicle braking systems ability to affect a braking operation upon at least one vehicle roadwheel. A Low-Speed Curvature Capability 132 may also be supplied by a Low-Speed Curvature Capability module 133 as calculated in light of Final Steering Rate Capability 103. Thus, based at least upon the Vehicle Speed 117, either the Current-Speed Curvature Capability 122 or Low-Speed Curvature Capability 132 may be utilized based upon Vehicle Speed 117, which may be sensed by vehicle sensors or provided to the vehicle modules by any known method, to produce a Curvature Capability 123. Moreover, to determine a Final Curvature Capability 123, the Current-Speed Curvature Capability 122 is used when the Vehicle Speed signal 117 exceeds a predetermined threshold. If the Vehicle Speed signal 117 fails to exceed that threshold, the Low-Speed Curvature Capability calculation 132 provided by the Low-Speed Curvature Capability module 133 is used to determine the Final Curvature Capability 123. It should be noted that Curvature Capability 123 need not be the only output of the shown module or group of modules. Performance Degradation State 124 may also be output by a System/Component Degradation States module 125 which may take into account the Actuator Deceleration Capability 104, the Actuator Deceleration Capability 104, and the Final Steering Rate Capability 103. Additionally, a Final Acceleration Capability 136 may also be an output of the module or system of modules depicted. The Final Acceleration Capability 136 may be determined by correlating the Max Stable Acceleration 107 with an Actuator Acceleration Capability 134 which may be provided by an Actuator Acceleration Capability Calculation module 135 based at least upon the Drive Torque 128 which may be provided to the vehicle by sensors or any other known method.

In a number of illustrative variations, any of a Performance Degradation State signal, a Final Deceleration Capability signal, a Final Acceleration Capability signal, or a Curvature Capability signal used by a planner module to determine an autonomous vehicle path thus accounting for the state of degradation or health of any vehicle components, systems, or modules relevant to the task of autonomously following any path or trajectory provided by the planner module.

The following description of variants is only illustrative of components, elements, acts, products and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a method comprising: providing a steering system comprised of at least one steering, braking, or drive system component having an initial steering, braking, or drive system component integrity; using at least one vehicle sensor to sense any changes to any of the initial steering, braking, or drive, system component integrity of the at least one steering, braking, or drive system component; determining the state of health or degradation of the at least one steering, braking, or drive system component based at least upon the changes to the initial steering, braking, or drive system component integrity of the at least one steering, braking, or drive system component; using a vehicle capability module to determine a vehicle capability based at least upon the state of health or degradation of the at least one steering, braking, or drive system component; and, using the vehicle capability module to communicate the determined vehicle capability to another vehicle system, module or component.

Variation 2 may include the method of variation 1 wherein the vehicle capability module communicates with a planner module constructed and arranged to determine a first autonomous vehicle path and wherein the another vehicle system, module, or component is the planner module.

Variation 3 may include the method of variation 2 wherein the planner module determines a second autonomous vehicle path based at least upon the determined vehicle capability.

Variation 4 may include method of variation 3 wherein the steering system is a steering system capable of autonomously following a path communicated to it by the planner module and, subsequent to the determination of the second autonomous vehicle path by the planner module, begins autonomously steering in accordance with the second autonomous vehicle path.

Variation 5 may include the method of variation 3 wherein the determination of the second autonomous vehicle path further comprises correlating data about the first autonomous vehicle path to the determined vehicle capability.

Variation 6 may include the method of variation 5 wherein the data about the first autonomous vehicle path or determined vehicle capability data comprises road condition data.

Variation 7 may include the method of variation 5 wherein the data about the first autonomous vehicle path comprises traffic data.

Variation 8 may include any of the methods of variations 5, 6, 7, or 9, wherein the determination of the second autonomous vehicle path further comprises determining at least one autonomous vehicle path alternative to the first autonomous vehicle path and correlating data about the at least one autonomous vehicle path alternative to the first autonomous vehicle path to the determined vehicle capability.

Variation 9 may include any of the methods of variations 5, 6, 7, or 8, wherein the determination of the second autonomous vehicle path further comprises selecting the at least one autonomous vehicle path alternative to the first autonomous vehicle path as the second autonomous vehicle path based upon at least an estimated travel distance for the selected autonomous vehicle path.

Variation 10 may include either of the methods of variations 8 or 9 wherein the data about the at least one autonomous vehicle path alternative to the first autonomous vehicle path autonomous vehicle path comprises road condition data.

Variation 11 may include the either of the methods of variations 8 or 9 wherein the data about the at least one autonomous vehicle path alternative to the first autonomous vehicle path comprises traffic data.

Variation 12 may include a product comprising: A motion control system for a vehicle comprising an autonomous steering, braking, and drive system and a planner module, wherein the motion control system is configured to monitor at least one steering, braking, and drive system and determine at least one vehicle capability during travel based at least upon a state of health or degradation of the at least one steering, braking, or drive system, and wherein the planner module is configured to collect or receive at least one of the at least one vehicle capability from the motion control system.

Variation 13 may include any of the products of variations 12, 14, or 15, wherein the planner module is constructed and configured to compute a first autonomous vehicle path based at least upon at least one received determined vehicle capability.

Variation 14 may include any of the products of variations 12, 13, or 15, wherein the at least one steering, braking, or drive system comprises at least one roadwheel, and at least one actuator constructed and arranged to change an orientation of the at least one roadwheel with regard to a straightforward orientation, and wherein the determination of at least one vehicle capability is based at least upon the braking system's ability to change the orientation of the at least one roadwheel.

Variation 15 may include any of the products of variations 12, 13, or 14, wherein at least one steering, braking, or drive system comprises at least a roadwheel and a braking system configured to brake the at least one roadwheel, and wherein the determination of at least one vehicle capability is based at least upon the braking system's ability to brake the at least one roadwheel.

Variation 16 may include a product comprising: A vehicle motion controller constructed and arranged to monitor an autonomous vehicle steering, braking, or drive system, wherein the autonomous vehicle steering, braking, or drive system comprises at least one steering, braking, or drive component and the vehicle motion controller is configured to determine at least one steering, braking, or drive system capability over a period of operation of the autonomous vehicle steering, braking, or drive system by monitoring at least the state of health or degradation of the at least one steering, braking or drive component via onboard vehicle sensors, and wherein the vehicle motion controller is configured to communicate the determined steering, braking, or drive system capability of the at least one steering, braking, or drive component to at least one other vehicle system.

Variation 17 may include any of the products of claim 16, 18, 19, or 20, wherein the vehicle motion controller is not onboard a vehicle.

Variation 18 may include any of the products of claim 16, 17, 19, or 20, wherein the period of operation of the autonomous vehicle steering, braking, or drive system is a period encompassing numerous intermittent driving sessions during each of which a vehicle using the autonomous vehicle steering, braking, or drive system is started, driven, and then shut down.

Variation 19 may include any of the products of claim 16, 17, 18, or 20, further comprising a planner module configured to receive and interpret the communicated determined steering, braking, or drive system capability from the vehicle motion controller and to determine an autonomous vehicle path based at least upon the communicated determined steering, braking, or drive system capability.

Variation 20 may include any of the products of claim 16, 17, 18, or 19, wherein the planner module is not onboard a vehicle.

The above description of select variations within the scope of the invention is merely illustrative in nature and, thus, variations or variants thereof are not to be regarded as a departure from the spirit and scope of the invention.

1. A method comprising:
providing a steering system comprised of at least one steering, braking, or drive system component having an initial steering, braking, or drive system component integrity;
using at least one vehicle sensor to sense any changes to any of the initial steering, braking, or drive, system component integrity of the at least one steering, braking, or drive system component;
determining the state of health or degradation of the at least one steering, braking, or drive system component based at least upon the changes to the initial steering, braking, or drive system component integrity of the at least one steering, braking, or drive system component;
using a vehicle capability module to determine a vehicle capability based at least upon the state of health or degradation of the at least one steering, braking, or drive system component; and,
using the vehicle capability module to communicate the determined vehicle capability to another vehicle system, module or component.

2. The method of claim 1 wherein the vehicle capability module communicates with a planner module constructed and arranged to determine a first autonomous vehicle path and wherein the another vehicle system, module, or component is the planner module.

3. The method of claim 2 wherein the planner module determines a second autonomous vehicle path based at least upon the determined vehicle capability.

4. The method of claim 3 wherein the steering system is a steering system capable of autonomously following a path communicated to it by the planner module and, subsequent to the determination of the second autonomous vehicle path by the planner module, begins autonomously steering in accordance with the second autonomous vehicle path.

5. The method of claim 3 wherein the determination of the second autonomous vehicle path further comprises correlating data about the first autonomous vehicle path to the determined vehicle capability.

6. The method of claim 5 wherein the data about the first autonomous vehicle path or determined vehicle capability data comprises road condition data.

7. The method of claim 5 wherein the data about the first autonomous vehicle path comprises traffic data.

8. The method of claim 5 wherein the determination of the second autonomous vehicle path further comprises determining at least one autonomous vehicle path alternative to the first autonomous vehicle path and correlating data about the at least one autonomous vehicle path alternative to the first autonomous vehicle path to the determined vehicle capability.

9. The method of claim 8 wherein the determination of the second autonomous vehicle path further comprises selecting the at least one autonomous vehicle path alternative to the first autonomous vehicle path as the second autonomous vehicle path based upon at least an estimated travel distance for the selected autonomous vehicle path.

10. The method of claim 8 wherein the data about the at least one autonomous vehicle path alternative to the first autonomous vehicle path comprises road condition data.

11. The method of claim 8 wherein the data about the at least one autonomous vehicle path alternative to the first autonomous vehicle path comprises traffic data.

12. A product comprising:
a motion control system for a vehicle comprising an autonomous steering, braking, and drive system and a planner module, wherein the motion control system is configured to monitor at least one steering, braking, and drive system and determine at least one vehicle capability during travel based at least upon a state of health or degradation of the at least one steering, braking, or drive system, and wherein the planner module is configured to collect or receive at least one of the at least one vehicle capability from the motion control system.

13. The product of claim 12 wherein the planner module is constructed and configured to compute a first autonomous vehicle path based at least upon at least one received determined vehicle capability.

14. The product of claim 12 wherein the at least one steering, braking, or drive system comprises at least one roadwheel, and at least one actuator constructed and arranged to change an orientation of the at least one roadwheel with regard to a straightforward orientation, and wherein the determination of at least one vehicle capability is based at least upon the braking system's ability to change the orientation of the at least one roadwheel.

15. The product of claim 12 wherein at least one steering, braking, or drive system comprises at least a roadwheel and a braking system configured to brake the at least one roadwheel, and wherein the determination of at least one vehicle capability is based at least upon the braking system's ability to brake the at least one roadwheel.

16. A product comprising:
a vehicle motion controller constructed and arranged to monitor an autonomous vehicle steering, braking, or drive system, wherein the autonomous vehicle steering, braking, or drive system comprises at least one steering, braking, or drive component and the vehicle motion controller is configured to determine at least one steering, braking, or drive system capability over a period of operation of the autonomous vehicle steering, braking, or drive system by monitoring at least the state of health or degradation of the at least one steering, braking or drive component via onboard vehicle sensors, and wherein the vehicle motion controller is configured to communicate the determined steering, braking, or drive system capability of the at least one steering, braking, or drive component to at least one other vehicle system.

17. The product of claim 16 wherein the vehicle motion controller is not onboard a vehicle.

18. The product of claim 16 wherein the period of operation of the autonomous vehicle steering, braking, or drive system is a period encompassing numerous intermittent driving sessions during each of which a vehicle using the autonomous vehicle steering, braking, or drive system is started, driven, and then shut down.

19. The product of claim 16 further comprising a planner module configured to receive and interpret the communicated determined steering, braking, or drive system capability from the vehicle motion controller and to determine an autonomous vehicle path based at least upon the communicated determined steering, braking, or drive system capability.

20. The product of claim 19 wherein the planner module is not onboard a vehicle.
